(19) United States
(12) Patent Application Publication
(10) Pub. No.: US 2008/0072084 A1
(43) Pub. Date: Mar. 20, 2008

(54) Method for Power Management

(76) Inventors: Chao-Kuang Yang, Sijhih City (TW); Yung-Hui Hou, Sijhih City (TW); Tzu-Lung Chuang, Sijhih City (TW)

Correspondence Address: LAW OFFICES OF LAI AND ASSOCIATES, P.C., 5800 RANCHESTER STE 200, HOUSTON, TX, 77036, US

(21) Appl. No.: 11/533,488

(22) Filed: Sep. 20, 2006

(51) Int. Cl. G06F 1/32

(52) U.S. Cl. 713/320

(57) ABSTRACT

A power management method is applied to a computer at a standby mode. When the computer in the standby mode idles more than a predetermined time, a firmware control program is activated. System state data contained in a first storage device of the computer is stored in a second storage device through the firmware control program. The first storage device and the second storage device are powered off The firmware control program is then turned off When the computer receives a trigger signal, the firmware control program is activated. The first storage device and the second storage device are powered on. The system state data stored in the second storage device is stored in the first storage device through the firmware control program. Lastly, the operating system of the computer is activated to allow the computer to return to a normal operating state.

### FIELD OF THE INVENTION

The present invention relates to a power management method, and more particularly to a power management method capable of adequately saving electric power without consuming too much time on an idle during a change of modes.

### BACKGROUND OF THE INVENTION

In a traditional power management method applied to a computer at a standby mode, a system state data is stored in a physical memory, and thus a memory module, a memory controller and a keyboard still will consume power. However, its advantage resides on providing a faster speed for entering a computer into a standby mode and resuming a normal operating state from the standby mode, and such process generally takes approximately three seconds. Comparatively speaking, the computer must take a longer time to enter into a sleep mode, and such process generally takes approximately 30 seconds, and the process of resuming a normal operating state from the sleep mode generally takes approximately 25 seconds. The advantage resides on that the system state data is stored in a hard disk, so that we do not have to worry about any data loss during the shutdown. The computer will be turned off to maximize the power saving effect. Since two power management modes have their respective advantages, therefore the inventor of the present invention intended to develop a power management method for saving electric power adequately without consuming too much time on an idle during a change of modes.

To satisfy the foregoing requirements, the inventor of the present invention based on years of experience in the related industry invents a power management method to overcome the shortcomings of the prior art.

### SUMMARY OF THE INVENTION

Therefore, it is a primary objective of the present invention is to provide a power management method capable of adequately saving electric power without consuming too much time on an idle during a change of modes.

To achieve the foregoing objective, the power management method of the invention is applied to a computer which enters into a standby mode, and the power management method comprises the following steps:

(a) When the computer idles in a standby mode more than a predetermined time, a firmware control program is activated;

(b) The system state data contained in a first storage device of a computer is stored into a second storage device through a firmware control program.

(c) The first storage device and the second storage device are powered off

(d) The firmware control program is terminated.

(e) If a trigger signal is received, the firmware control program will be activated.

(f) The first storage device and the second storage device are powered on.

(g) The system state data stored in the first storage device is stored in the second storage device through the firmware control program.

(h) The operating system of the computer is activated to resume the computer to a normal operating state.

Since the power management method of the invention processes the transmissions of the system state data by the firmware control program, the operating system just enters a computer into a standby mode, and the operating system will not be aware of the computer entering into the power management method of the invention. Therefore, it is not necessary to make any modification to the operating system program. In prior arts, the operating system controls the process of entering the computer from a standby mode into a sleep mode. If the system resource is insufficient, there will be a risk of unsuccessfully switching the computer into a sleep mode. The present invention controls the switching by a firmware control program, and thus it can avoid the aforementioned problem. Since the firmware control program can control the memory state, therefore not all of the system state data are necessarily stored in a hard disk, and a portion of the system state data is stored in other nonvolatile storage device according to user requirements. The power management method in accordance with the present invention does not show a boot screen of the basic input/output system (BIOS) when the computer wakes up from a sleep mode, and thus it can further save approximately 8˜10 seconds for the time of the resumption.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a flow chart of a power management method of the present invention;

FIG. 2 is a flow chart of a power management method entering a computer into a standby mode in accordance with the present invention;

FIG. 3 is a flow chart of a power management method storing a system data in accordance with the present invention;

FIG. 4 is a flow chart of a power management method resuming a computer to a normal operating state in accordance with the present invention; and

FIG. 5 is a schematic view of a power management method in accordance with a preferred embodiment of the present invention.

### DETAILED DESCRIPTION OF THE PREFERRED EMBODIMENTS

For simplicity, the same symbol or label is used for the same element for the description of a preferred embodiment of a power management method in accordance with the present invention.

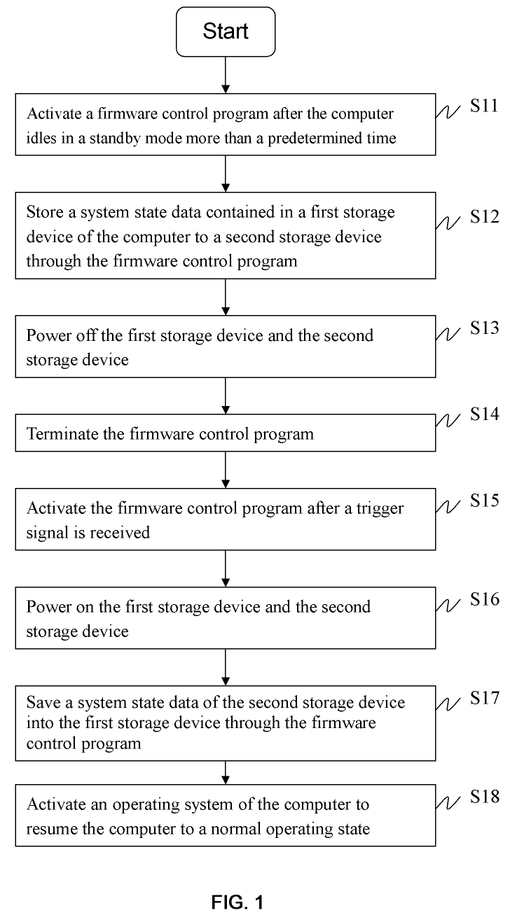

Referring to FIG. 1 for a flow chart of a power management method in accordance with the present invention, the method is applied to a computer, and the computer enters into a standby mode, and the power management method comprises the following steps:

Step S11: Activate a firmware control program after the computer idles in a standby mode more than a predetermined time;

Step S12: Store a system state data contained in a first storage device of the computer to a second storage device through the firmware control program;

Step S13: Power off the first storage device and the second storage device;

Step S14: Terminate the firmware control program;

Step S15: Activate the firmware control program after a trigger signal is received;

Step S16: Power on the first storage device and the second storage device;

Step S17: Save a system state data of the second storage device into the first storage device through the firmware control program; and

Step S18: Activate an operating system of the computer to resume the computer to a normal operating state.

The aforementioned standby mode is a S3 power management mode; the aforementioned firmware control program is a basic input/output system (BIOS); and the aforementioned second storage device is a nonvolatile storage device.

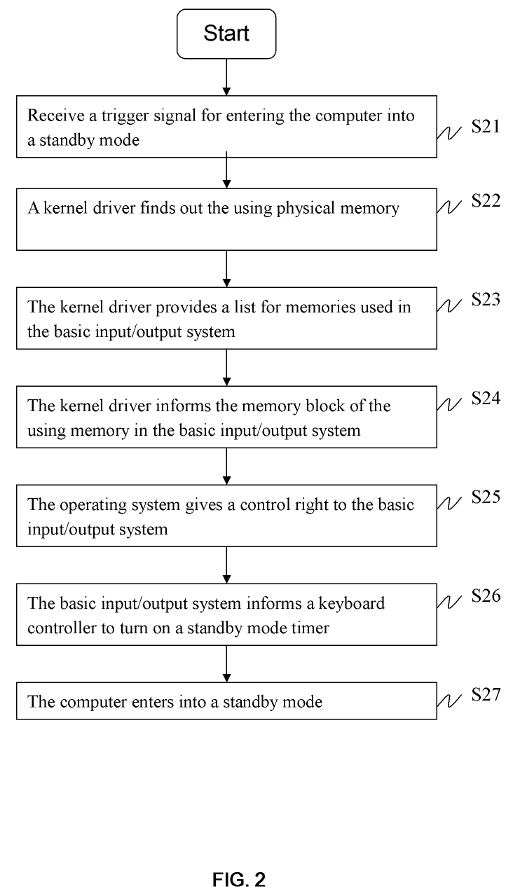

Referring to FIG. 2 for a flow chart of a power management method entering a computer into a standby mode in accordance with the present invention, the method comprises the following steps:

Step S21: Receive a trigger signal for entering a computer into a standby mode;

Step S22: A kernel driver finds out the using physical memory;

Step S23: The kernel driver provides a list for memories used in the basic input/output system;

Step S24: The kernel driver informs the memory block of the using memory in the basic input/output system;

Step S25: The operating system gives the control right to the basic input/output system;

Step S26: The basic input/output system informs a keyboard controller to turn on a standby mode timer; and

Step S27: The computer enters into a standby mode.

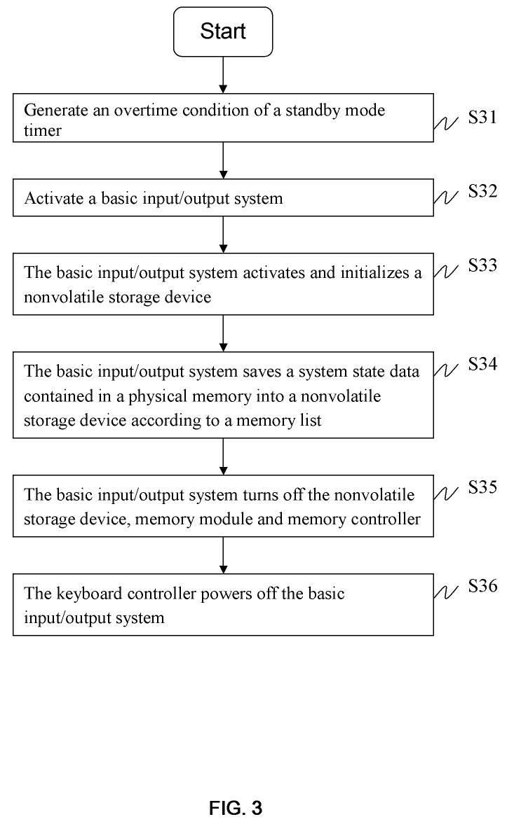

Referring to FIG. 3 for a flow chart of a power management method storing a system state data in accordance with the present invention, the method comprises the following steps:

Step S31: Generate an overtime condition of a standby mode timer;

Step S32: Activate a basic input/output system;

Step S33: The basic input/output system activates and initializes a nonvolatile storage device;

Step S34: The basic input/output system saves a system state data contained in a physical memory into a nonvolatile storage device according to a memory list;

Step S35: The basic input/output system turns off the nonvolatile storage device, memory module and memory controller; and

Step S36: The keyboard controller turns off the basic input/output system.

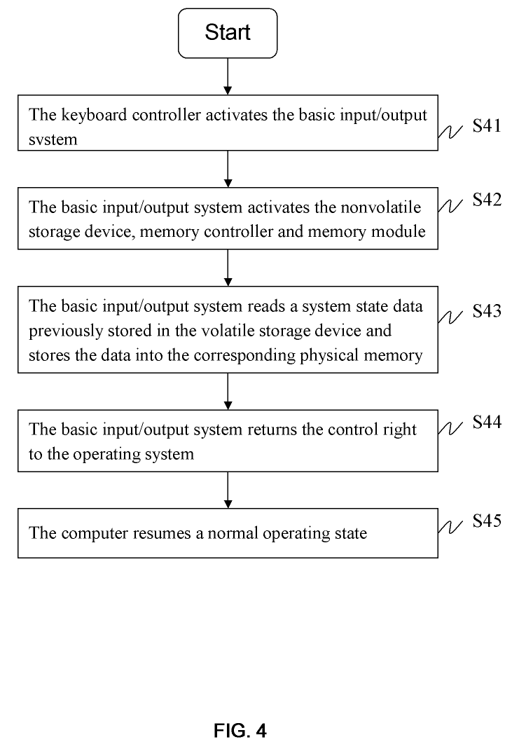

Referring to FIG. 4 for a flow chart of a power management method resuming a computer to a normal operating state in accordance with the present invention, the method comprises the following steps:

Step S41: The keyboard controller activates the basic input/output system;

Step S42: The basic input/output system activates the nonvolatile storage device, memory controller and memory module;

Step S43: The basic input/output system reads a system state data previously stored in the volatile storage device and stores the data into the corresponding physical memory;

Step S44: The basic input/output system returns the control right to the operating system; and

Step S45: The computer resumes a normal operating state.

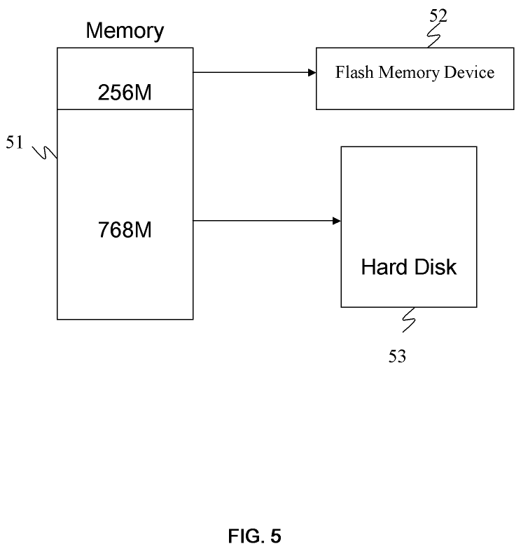

Referring to FIG. 5 for a schematic view of a power management method in accordance with a preferred embodiment of the present invention, the power management method uses a basic input/output system to store a system state data contained in a memory into a nonvolatile storage device, since the basic input/output system can control the capacity of the stored memories. Therefore, a portion of system state data can be stored in a nonvolatile storage device, and a portion of system state data can be stored in another nonvolatile storage device. In this preferred embodiment, 256M of system state data contained in the memory is stored into a flash memory, and 768M of system state data is stored into a hard disk. Further, a portion of system state data can be stored into a remote storage device through a network, so as to achieve a more flexible application.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power management method, applied to a computer which enters into a standby mode, said power management method comprising the steps of:
activating a firmware control program, if said computer idles in a standby mode more than a predetermined time;
storing a system state data contained in a first storage device of said computer into a second storage device through said firmware control program;
powering off said first storage device and said second storage device;
terminating said firmware control program;
activating said firmware control program, if a trigger signal is received;
powering on said first storage device and said second storage device;
storing said system state data of said second storage device into said first storage device through said firmware control program; and
activating an operating system of said computer to resume said computer to a normal operating state.

2. The power management method of claim 1, wherein said standby mode is a S3 power management mode.

3. The power management method of claim 1, wherein said firmware control program is a basic input/output system (BIOS).

4. The power management method of claim 1, wherein said first storage device is a memory of said computer.

5. The power management method of claim 1, wherein said second storage device comprises at least one nonvolatile storage device.

6. The power management method of claim 5, wherein said nonvolatile storage device is a hard disk or a flash memory device.

7. The power management method of claim 1, wherein said trigger signal is generated by a user through a keyboard or a mouse of said computer.
